(19) United States
(12) Patent Application Publication
(10) Pub. No.: US 2008/0310932 A1
(43) Pub. Date: Dec. 18, 2008

(54) Washer

(76) Inventors: Dale Michael McIntyre, Auckland (NZ); James Malcolm Buchanan, Auckland (NZ); Shane Robert Reckin, Auckland (NZ); Henricus Jacobus Johannes Hermans, Auckland (NZ)

Correspondence Address: JACOBSON HOLMAN PLLC, 400 SEVENTH STREET N.W., SUITE 600, WASHINGTON, DC, 20004, US

(21) Appl. No.: 11/794,097

(22) PCT Filed: Dec. 21, 2005
(86) PCT No.: PCT/NZ2005/000338

§ 371 Date: May 28, 2008

(30) Foreign Application Priority Data
Dec. 24, 2004 (NZ) 537537

(51) Int. Cl. F16B 39/24

(52) U.S. Cl. 411/150

(57) ABSTRACT

A washer adapted to minimise contamination by avoiding in use inappropriate crevices. metal annular disc having an annular rebate on at least one face to its outer periphery, and a unitary formation of a flexible medium (e.g. of a food grade rubber) (A) preferably more than filling the or each rebate and (B) surrounding the outer periphery of the disc.

### TECHNICAL FIELD

The present invention relates to a method of avoiding unsanitary crevices under bolt heads or nuts, related assemblies and procedures and a suitable washer, associated methods for its use in such an assembly, its method of manufacture etc.

### BACKGROUND ART

In food handling equipment there is frequently a need to bolt components together and this can lead to a bolt head or nut bearing on a surface of a component or on an interposed washer. Either way, even with hexagonal form unbevelled nut faces there is the prospect of crevices being formed.

The present invention wishes to provide a hybrid washer that has the prospect of not presenting any substantial crevice of a detrimental kind between the bolt head or nut and the washer or between the washer and a component.

### DISCLOSURE OF INVENTION

With a view therefore to meeting the aforementioned aims envisaged is a washer having a plastics and/or silicone rubber formation positioned so as to be compressible under the action of a suitably sized bolt or nut head and/or a component to present a continuous surface of that formation with squeezing mean no unsanitary crevices between the bolt head/nut and component. Preferably the washer is of a kind substantially as hereinafter described.

In still a further aspect the present invention consists in a washer comprising an annular disc (preferably of metal) having its periphery and its outer annular region on each face covered with a food grade flexible medium (e.g. a resilient plastics or silicone material) (e.g. as a moulded formation).

Preferably the extent of the covering is substantially as hereinafter described.

Preferably one or both sides of the washer is of a rebated form for the purpose of accommodating a sufficient depth of the material to enable sealing by the flexible medium yet disc to metal contact.

In another aspect the invention is a washer having

a metal annular disc (moulded, stamped and/or machined) having an annular rebate on one or each face to its outer periphery, and

a unitary formation of a food grade flexible medium (e.g. a plastics and/or silicone material) filling the or each rebate (or at least substantially filling each rebate) and surrounding the outer periphery of the disc.

Preferably the at least substantially filling of each rebate is to a depth at least as deep as and preferably greater than the depth of the rebate. In less preferred forms of the present invention, in another aspect the invention, is a washer as aforesaid but rebated on one side only but having the unitary formation extending over each face in one case to fill or substantially fill the rebate.

In even other options annular location and/or other profiling features can be provided on a metal annular disc so as to assist in location and depth of available plastics and/or silicone rubber material for surrounding the metal annular disc and conferring compressibility as a peripheral feature for outer annular regions of the formation.

In yet a further aspect the present invention consists in variations of a washer as aforesaid that nonetheless confers the benefit described i.e. has an ability whereby a food grade flexible medium (e.g. resilient plastics and/or silicone material) will be compressed as the washer serves its spacing function and/or its other roles under a bolt head or nut.

In yet a further aspect the present invention consists in a method of moulding about a washer when performed substantially as hereinafter described to provide a washer of any of the aforementioned kinds.

In still a further aspect the present invention consists in an assembly where a washer in accordance with the present invention has at least one of a component, bolt head or nut bearing on each side thereof.

### BRIEF DESCRIPTION OF DRAWINGS

A preferred form of the present invention will now be described with reference to the accompanying drawings in which

FIG. 1 is a perspective view of a preferred washer in accordance with the present invention,

FIG. 2 is a cross section through the centre of the disc of FIG. 1,

FIG. 3 is one mould component for moulding the food, grade flexible medium (e.g. plastics and/or silicone material) about a metal annular disc,

FIG. 4 is the complementary mould component to that of FIG. 3 to mould a disc as shown in FIG. 2 interposed therebetween,

FIG. 5 shows two washers in accordance with the present invention each providing sealed interfaces between a component and a nut between the unbevelled face of a hexagon nut and the component,

FIG. 6 shows in plan another preferred washer of the present invention,

FIG. 7 shows the section at A-A of the washer of FIG. 6, and

FIG. 8 is a perspective view of the embodiment of FIGS. 6 and 7.

In the preferred form of the present invention the scaling of the washer is such that the metal disc with its central opening and its preferred rebates to each outer periphery can be stamped or otherwise formed to a configuration as shown as 1. Thereafter, in the complementary mould components 2 and 3, there is then injection moulded onto the metal annular disc 1 the formation 4 which is a unitary formation of material capable of extending to a thickness slightly greater than the distance face to face of the unrebated regions of the annular disc 1.

Preferably such a depth is such that there is a sealed interface at each of positions 5 and 6, in one case (5), between the formation 4 and the nut 7, and in the other case, between the formation 4 and a component 8. Such compression as occurs of the material is such as to extend the outer perimeter thereof 9 out beyond the extent of the nut or bolt head yet still make a crevice free contact with the component 8 or the equivalent.

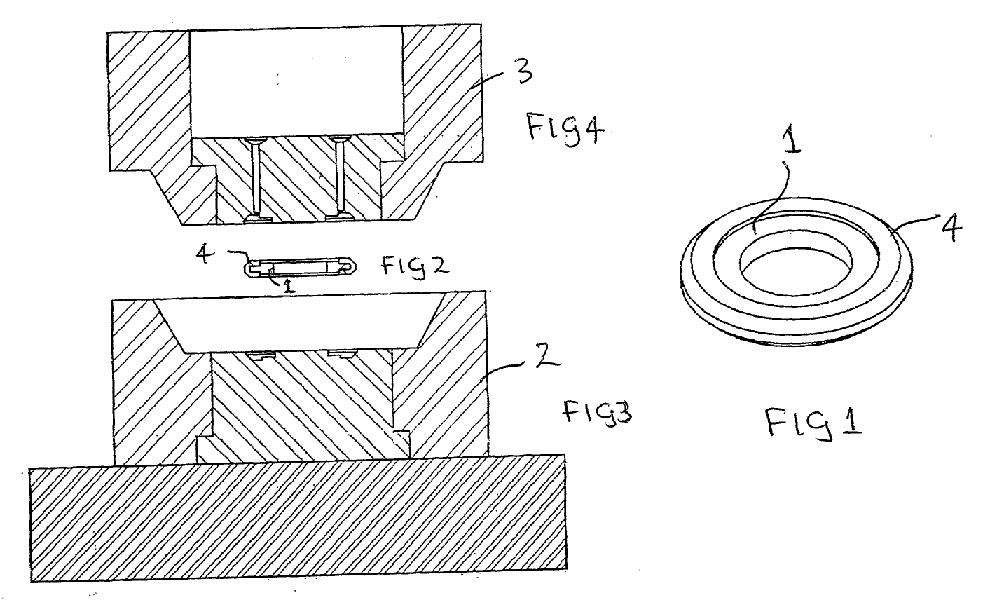

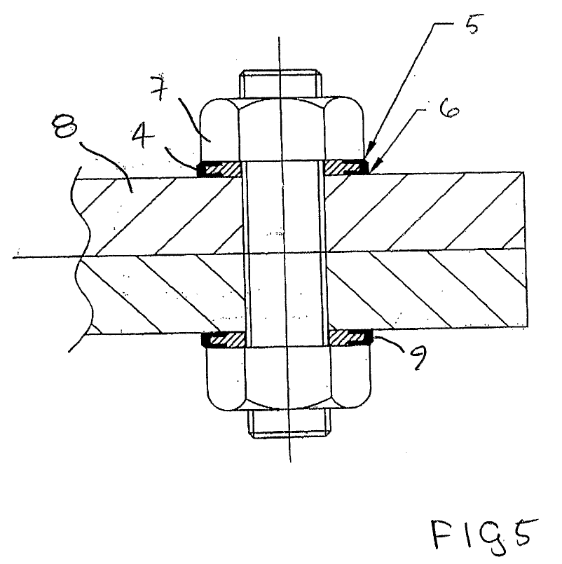

A preferred moulding technique is that depicted by reference to FIGS. 2, 3, and 4, all being shown in the same cross section.

Preferably materials from the moulded formation is a mouldable plastic or rubber (e.g. preferably a “food grade” rubber, e.g. silicone rubber, nitrile rubber, buna rubber, and the like) and for the metal or other material carrying that formation is stainless steel.

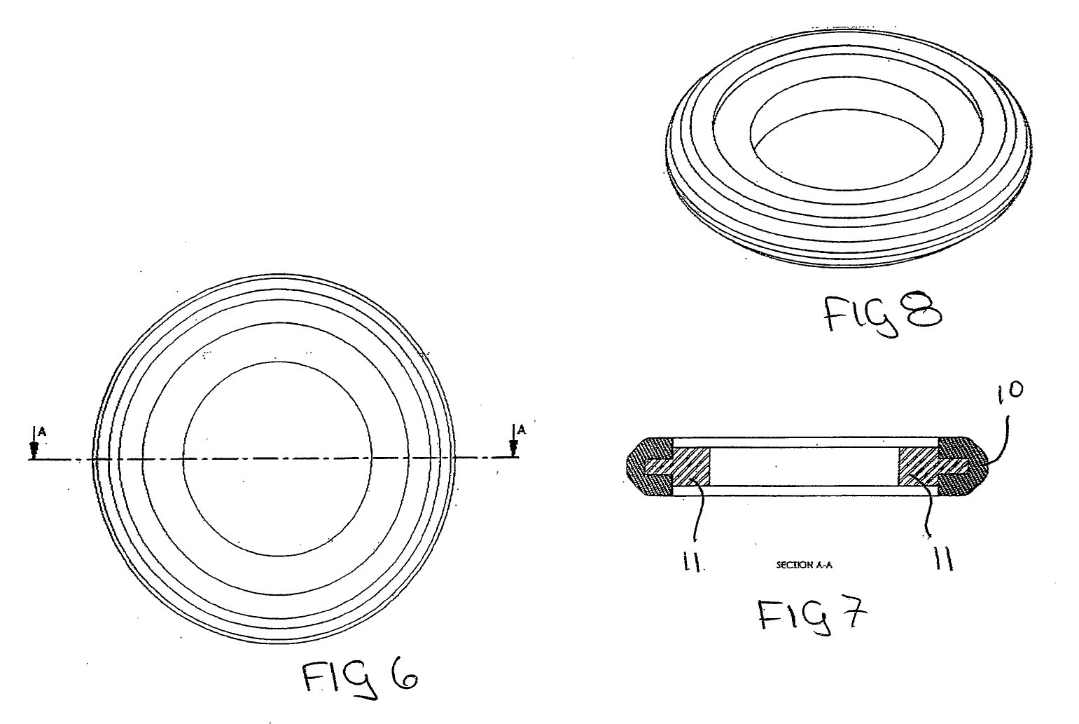

FIGS. 6 to 8 shows a preferred form where a silicone “rubber” 0 has been moulded onto a stainless steel disc 11 of the section shown. It can be seen that there is more radius on the corners of the formation 10.

Nonetheless the effect of squeeze on the formation 10 down to almost the thickness of the metal 11 at its greatest thickness has the effect of presenting a seal to surfaces from easily stertilisable crevices.

1. A washer having
a metal annular disc having an annular rebate on at least one face to its outer periphery, and
a unitary formation of a flexible medium filling at least part of the or each rebate and surrounding the outer periphery of the disc.

2. The washer of claim 1 wherein there is a rebate on each face of the disc.

3. The washer of claim 1 where the filling at least in part of the or each rebate is to a depth at least as deep as the depth of the or each rebate.

4. The washer of claim 2 wherein the filling is to a depth of greater than the depth of the or each rebate.

5. A washer comprising an annular disc having its periphery and its outer annular region on each face covered with a flexible medium.

6. The washer of claim 5 wherein said flexible medium is a resilient plastics, rubber silicone or silicone rubber material.

7. The washer of claim 5 wherein the flexible medium has been molded onto the disc as a moulded formation.

8. (canceled)

9. A washer wherein one or both sides of the washer is of a rebated form for the purpose of accommodating a sufficient depth of a flexible material to enable sealing by the flexible material.

10. A washer having a plastics and/or silicone rubber formation positioned so as to be compressible in use to present a continuous surface of that formation without the squeezing providing unsanitary crevices between a complementary bolt head/nut and component.

11. The washer having a plastics and/or silicone rubber formation positioned so as to be compressible in use to present a continuous surface of that formation without the squeezing providing unsanitary crevices between a complementary bolt head/nut and component that is also a washer of claim 1.

12. A hybrid washer that has the prospect of not presenting any substantial crevice of a detrimental kind between a complementary bolt head or nut and the washer or between the washer and a complementary component.

13. A method of moulding about a washer when performed substantially as herein described.

14. The assembly comprising a washer in accordance with claim 1 and at least one of a component, bolt head or nut bearing on a first side thereof and at least one of a component, bolt head or nut bearing on a second side thereof.
